(19) United States
(12) Patent Application Publication
(10) Pub. No.: US 2024/0424527 A1
(43) Pub. Date: Dec. 26, 2024

(54) SILICONE COMPOSITIONS AND THEIR APPLICATIONS

(71) Applicant: DOW SILICONES CORPORATION, Midland, MI (US)

(72) Inventors: Justin GATHMAN, Midland, MI (US); William JOHNSON, Midland, MI (US); Chris WINDIATE, Midland, MI (US); Cody SCHOENER, Midland, MI (US)

(21) Appl. No.: 18/708,228

(22) PCT Filed: Nov. 8, 2022
(86) PCT No.: PCT/US2022/049247

§ 371 Date: May 8, 2024

Related U.S. Application Data
(60) Provisional application No. 63/283,559, filed on Nov. 29, 2021.
(60) Provisional application No. 63/277,704, filed on Nov. 10, 2021.

(51) Int. Cl. B05D 5/00; C08G 77/08; C08G 77/20; C08K 5/544; C08K 9/04; C09D 7/62; C09D 7/63; C09D 183/04

(52) U.S. Cl. CPC B05D 5/00; C08G 77/08; C08G 77/20; C08K 5/544; C08K 9/04; C09D 7/62; C09D 7/63; C09D 183/04; B05D 2320/00; B05D 2401/31; B05D 2518/12; B05D 2601/20; C08K 2201/006

(57) ABSTRACT

Provided is a method for providing a substrate with an ablative coating using a one-part room temperature curable and sprayable ablative silicone composition. The one-part room temperature curable and sprayable ablative silicone composition is generally thixotropic and cures in depth within 24 hours to provide an ablative or thermal protective layer on an article. The one-part room temperature curable and sprayable ablative silicone composition is substantially free from diluents or solvents. An article having such a coating and the use of the one-part room temperature curable and sprayable ablative silicone composition in the preparation of such an article are also provided.

The present disclosure generally relates to a method for providing a substrate with an ablative coating using a one-part room temperature curable and sprayable ablative silicone composition which is thixotropic and cures in depth within 24 hours to provide an ablative or thermal protective layer on an article. The one-part room temperature curable and sprayable ablative silicone composition is substantially free from diluents or solvents. The ablative or thermal protective coating is designed to provide high-heat resistance (i.e., up to or even greater than (>) 3000° C.) or direct flame-resistance suitable for protection of heat-sensitive apparatus in e.g., missiles, aircraft and spacecraft, through conversion of the resulting cured silicone ablative layer to silica/char. Conventional methods that are used to protect substrates from the effects of high-temperature heat exposure or flame contact include the use of solid heat tiles, such as those used on the space shuttle, that are applied to the substrate surface using a high-temperature adhesive. The tiles are only effective as long as they remain adhered to the underlying substrate surface and are known to break away from the substrate surface due to both the differences in thermal expansion characteristics of the substrate and tile, and to the forces acting on the tiles by the high-temperature heat source, i.e., a rocket engine exhaust. Once a tile is removed, the underlying substrate becomes exposed to the harmful high-temperature heat and this can also serve as a propagation point for more tiles to be lost from the surrounding area. Therefore, the use of thermal protective coatings and/or layers using ablative materials is being increasingly used.

Thermal protective coatings and/or layers of ablative materials are applied onto substrates so that instead of heat being transmitted into the structure of e.g., a missile, aircraft or spacecraft, the ablative layer bears the majority of the heating effect. The substrates concerned are those materials which are subjected to high-heat, direct or indirect flame impingement and/or significant friction (i.e., hypersonic missiles) such as steel structures, cement trenches, rockets, heat shields, rocket engines, missiles, missile nose cones, missile deployment devices or the like.

In use, the outer surface of the ablative coating and/or layer applied onto such a substrate, when subjected to such a heating effect, will gradually char, and/or sublime while the bulk of the ablative coating and/or layer may undergo pyrolysis expelling resulting gases. The heat is carried away from the e.g., missile, aircraft or spacecraft structure by said resulting gases and therefore is prevented from significantly penetrating the substrate (structure) onto which the ablative coating and/or layer has been applied, thus maintaining the substrate/structure at a safe temperature. The thickness of the ablative coating and/or layer is calculated to be sufficient to survive the heat it will encounter on its mission.

However, many historical ablative compositions rely on epoxy and polyurethane materials that provide only limited heat resistance of from about 1000° C. to 1500° C. and as such are not suitable for higher temperature applications e.g. greater than (>) 2000° C. and furthermore provide poor ultraviolet, weather resistance, and acid resistance, can lack flexibility, and can give off toxic fumes when burning.

Traditional ablative coating compositions may be applied onto substrates by being rolled, troweled, painted and/or sprayed, with or without volatile organic compounds (VOCs) and can be thixotropic or non-thixotropic.

Many ablative coatings and/or layers formed from conventional ablative coating compositions need to be cured in place at an elevated temperature, i.e., cure above ambient outdoor temperature and may even require a cure process involving subjecting an applied ablative coating composition to increasingly elevated temperatures for specified periods of time which renders the use of such ablative coating compositions complicated and time consuming to use. This is especially true when the substrate being coated is a large structure, such as a launch pad for a rocket or the outer surface of a rocket, requiring that the cure process either be carried out by exposing the entire coated surface to the necessary curing heat in a large oven and the like, or by curing coated sections of the substrate sequentially using a locally applied heat source.

Most filled silicone elastomers will exhibit at least some tendency to form a surface char when exposed to high-heat and especially direct or indirect flame impingement and as such may be used as silicone ablative compositions. Once cured the resulting silicone ablative coatings and/or layers function as ablatives in that as the elastomeric material is heated, the original surface material is designed to pyrolyze resulting in the generation of a porous residue, or char. The surface of the char layer may then recede as heating continues. Traditional silicone ablative compositions include two-part hydrosilylation (addition) cure compositions which cure at elevated temperatures and two-part condensation cure compositions.

Furthermore, by utilising unique fibers to aid in char formation and char retention prior art silicone ablatives may have unique, intumescent ablative properties where the ablated bulk actually absorbs the heat of the reaction causing the cured bulk to “swell” slightly during ablation before shrinking during cooling. The fibers form a network within the cured bulk resulting in a brittle char layer. Such compositions are generally applied onto a substrate surface by troweling which can be a slow process, particularly when coating large surface areas.

Silicone ablative compositions have been prepared for use in spraying applications. However, such compositions were typically diluted with solvent(s). Whilst such diluted coating compositions can be used for spraying, they have the disadvantage of only being able to produce thin coating thicknesses of e.g., up to 1.27 mm before they have flow/slump problems (sometimes referred to as creep) due to the dilution. Furthermore, whilst such coatings may be coated on substrate surfaces at thicknesses of up to about 1.27 mm, the diluent contained therein is designed to evaporate as the composition cures when can lead to the cured coating thickness being up to about half the thickness of the uncured coating which tends to necessitate 3 to 5 repeat applications to build up an ablative of coating of suitable thickness over several layers and each time a new layer is applied it requires a period of up to 12 hours for the coating to be sufficiently cured before a further layer can be overcoated. This of course means that it can take up to two or three days for a satisfactory ablative coating to have been generated before next application and because the diluent is typically an organic solvent such coatings often release VOCs during the evaporation thereof during each cure process.

Hence, the use of silicone ablative compositions is attractive, not least because they are capable of forming a heat ablative coating having elastomeric properties to provide a degree of flexibility and impact resistance. They also provide protective coatings that have good ultraviolet, weather and acid resistance, and that do not generate toxic fumes when exposed to high temperature conditions. However, the hydrosilylation cured silicone compositions are cured at elevated temperatures (i.e., above room temperature) which in some instances make them undesirable. Silicone condensation cure compositions cure significantly slower, for example, one part titanate cured condensation compositions can take e.g., up to 7 days curing per 6 mm of depth of the body of the uncured material. Tin cured condensation systems do cure over a shorter period, but they have the disadvantage (in some situations) of undergoing reversion (i.e., depolymerisation) at temperatures above 80° C.

Hence, there remains a need for a method for providing a substrate with an ablative coating comprising a condensation curable silicone ablative coating composition which is sprayable and yet sufficiently thixotropic to be applied onto substrates in a single coating at a thickness of between 2.5 mm and 5 mm and which can cure at room temperature without the release of VOCs due to the evaporation of organic diluents during the cure process.

There is provided herein a method for providing a substrate with an ablative coating comprising the steps of
(I) Preparing a one-part room temperature curable and sprayable ablative silicone composition by mixing at high shear in a high shear mixer and/or using a twin-screw extruder, wherein said one-part room temperature curable and sprayable ablative silicone composition comprises
   (a) an organopolysiloxane of the structure

D—Z—(R¹)_{y}SiO_{(4-y)/2})_{z}—SiR¹₂—Z—D

wherein D is either:
(i) —Si—RₙX₃₋ₙ or
(ii) —Si(R¹)₂—O—Si(R¹)(O—Si(R¹)₂—Z¹—Si—RₙX₃₋ₙ)₂
   wherein each R¹ is the same or different and is an alkyl group, alkenyl group or aryl group, each Z and Z¹ is a divalent organic group, the average value of y is about 2, z is the number average degree of polymerization and is an integer of at least 50, each X is a hydroxyl group or alkoxy group, each R is individually selected from an alkyl group, an aminoalkyl group, polyaminoalkyl group, an epoxyalkyl group, an alkenyl group or an aromatic group and n is 0, 1 or 2;
(b) Precipitated calcium carbonate having a BET surface area of at least 15 m²/g which may be hydrophobically treated;
(c) One or more non-fibrous, non-reinforcing fillers,
   wherein the cumulative wt. % of components (b) and (c) is from 40 to 60 wt. % of the composition and the weight ratio of precipitated calcium carbonate (b) to the one or more non-fibrous, non-reinforcing fillers, (c) is from 1:2 to 1:7;
(d) a silane cross-linker having the structure

R⁷_{c}—Si—R⁶_{4-c}

wherein each R⁷ is an alkoxy group having from 1 to 10 carbons, a ketoximino group or an alkenyloxy group; each R⁶ is selected from is a non-hydrolysable silicon-bonded organic group, and c is 2, 3 or 4;
(e) a titanate or a zirconate condensation reaction catalyst;
   which composition is substantially free from diluents or solvents;
   which one-part room temperature curable and sprayable ablative silicone composition resulting from step (I) has an extrusion Rate of 1900 to 2600 g/min when measured in accordance with ASTM C1183;
(II) spraying the resulting mixture of step (I) onto a substrate surface to produce a thixotropic curable coating on the substrate which has a coating thickness before any visible indication of slump/flow of from 2.5 to 5 mm measured using a wet film comb gauge, and
(III) allowing the composition to cure at room temperature.

There is also provided an article having an ablative coating obtainable or obtained by the process described above.

There is further provided an article having an ablative coating which is the cured product of a one-part room temperature curable and sprayable, ablative silicone composition comprising:
(a) an organopolysiloxane of the structure

D—Z—(R¹)_{y}SiO_{(4-y)/2})_{z}—SiR¹₂—Z—D

wherein D is either:
(i) —Si—RₙX₃₋ₙ or
(ii) —Si(R¹)₂—O—Si(R¹)(O—Si(R¹)₂—Z¹—Si—RₙX₃₋ₙ)₂
   wherein each R¹ is the same or different and is an alkyl group, alkenyl group or aryl group, each Z and Z¹ is a divalent organic group, the average value of y is about 2, z is the number average degree of polymerization and is an integer of at least 50, each X is a hydroxyl group or alkoxy group, each R is individually selected from an alkyl group, an aminoalkyl group, polyaminoalkyl group, an epoxyalkyl group, an alkenyl group or an aromatic group and n is 0, 1 or 2;
(b) Precipitated calcium carbonate having a BET surface area of at least 15 m²/g which may be hydrophobically treated;
(c) One or more non-fibrous, non-reinforcing fillers,
   wherein the cumulative wt. % of components (b) and (c) is from 40 to 60 wt. % of the composition and the weight ratio of precipitated calcium carbonate (b) to the one or more non-fibrous, non-reinforcing fillers, (c) is from 1:2 to 1:7;
(d) A silane cross-linker having the structure

R⁷_{c}—Si—R⁶_{4-c}

wherein each R⁷ is an alkoxy group having from 1 to 10 carbons, a ketoximino group or an alkenyloxy group; each R⁶ is selected from is a non-hydrolysable silicon-bonded organic group, and c is 2, 3 or 4;
(e) a titanate or a zirconate condensation reaction catalyst;
   which one-part room temperature curable and sprayable ablative silicone composition is substantially free from diluents or solvents and
   has an extrusion Rate of 1900 to 2600 g/min when measured in accordance with ASTM C1183;
   and after being sprayed onto a substrate surface to produce a thixotropic curable coating thereon has a coating thickness before any visible indication of slump/flow of from 2.5 to 5 mm measured using a wet film comb gauge.

There is also provided a use of a composition comprising
(a) an organopolysiloxane of the structure

D—Z—(R¹)_{y}SiO_{(4-y)/2})_{z}—SiR¹₂—Z—D

wherein D is either:
(i) —Si—RₙX₃₋ₙ or
(ii) —Si(R¹)₂—O—Si(R¹)(O—Si(R¹)₂—Z¹—Si—RₙX₃₋ₙ)₂
   wherein each R¹ is the same or different and is an alkyl group, alkenyl group or aryl group, each Z and Z¹ is a divalent organic group, the average value of y is about 2, z is the number average degree of polymerization and is an integer of at least 50, each X is a hydroxyl group or alkoxy group, each R is individually selected from an alkyl group, an aminoalkyl group, polyaminoalkyl group, an epoxyalkyl group, an alkenyl group or an aromatic group and n is 0, 1 or 2;
(b) Precipitated calcium carbonate having a BET surface area of at least 15 m²/g which; may be hydrophobically treated;
(c) One or more non-fibrous, non-reinforcing fillers,
   wherein the cumulative wt. % of components (b) and (c) is from 40 to 60 wt. % of the composition and the weight ratio of precipitated calcium carbonate (b) to the one or more non-fibrous, non-reinforcing fillers, (c) is from 1:2 to 1:7;
(d) A silane cross-linker (d) having the structure

R⁷_{c}—Si—R⁶_{4-c}

wherein each R⁷ is an alkoxy group having from 1 to 10 carbons, a ketoximino group or an alkenyloxy group; each R⁶ is selected from is a non-hydrolysable silicon-bonded organic group, and c is 2, 3 or 4; and
(e) a titanate or a zirconate condensation reaction catalyst;
which composition is substantially free from diluents or solvents and has an extrusion Rate of 1900 to 2600 g/min when measured in accordance with ASTM C1183; and after being sprayed onto a substrate surface to produce a thixotropic curable coating thereon has a coating thickness before any visible indication of slump/flow of from 2.5 to 5 mm measured using a wet film comb gauge; in the preparation of an ablative coating on a substrate.

High-shear mixers are well-known and are widely used in the chemical industry. A high-shear mixer disperses, or transports, one phase or ingredient (liquid, solid, gas) under high shear mixing into a main continuous phase (liquid), with which it would normally be immiscible or be difficult to mix. A rotor or impeller, together with a stationary component known as a stator, or an array of rotors and stators, is used either in a tank containing the solution to be mixed, or in a pipe through which the solution passes, to create shear. High shear mixers may function in either batch mode or in a continuous form. An example of a continuous high shear mixer being a twin-screw extruder which is very efficient high shear mixer that operates continuously. For high shear mixing the speed of rotation of the rotor(s) or screws in the case of twin-screw extruders may be e.g., 500 rpm or greater, e.g., 1000 rpm or 1500 rpm. In each case such values are determined by the high shear mixer being utilised, but the effects are substantially the same irrespective of high shear mixer type. Another way of defining such high-shear mixers is by a parameter generally referred to as the “tip speed or blade speed” which is a measure of how far a point on the outer most edge of the mixer blade travels in a given amount of time. It is determined by calculating the circumference of the path of the mixer blade in the mixer i.e., πD (where D is the diameter of the mixer blade) and multiplying it by the speed of rotation. Hence, high shear mixing may be undertaken in a high shear mixer with a tip speed of greater than 3.25 ms⁻¹, alternatively greater than 4.00 ms⁻¹, alternatively greater than 5.00 ms⁻¹. It was surprisingly found that the composition above was only suited for the application herein when mixed under high shear and it was found that when similar compositions were mixed using low-shear mixers they did not meet the necessary requirements herein.

The composition described herein is a one-part room temperature curable sprayable, ablative silicone composition which upon cure provides a substrate with an ablative coating.

Typically said silicone ablative coating is a topcoat on the substrate. It may for example be applied onto a layer of paint or another coating which had been previously applied onto the substrate surface prior to the addition of the ablative layer described herein or may be applied direct onto the substrate surface.

The substrate surfaces onto which the one-part room temperature curable and sprayable ablative silicone compositions are applied tend to be underlying substrates which otherwise during use would be exposed to the effects of high-temperature heat exposure and/or flame contact. Articles of which the substrates form a part may include aerospace vehicles, rocket parts such as nozzle units, combustion chambers and engine casings, re-entry space vehicles, missile parts such as missile nose cones, missile and rocket launch pads aircraft parts, heat shields and/or other articles containing an important structural member associated with the heat producing devices.

The ablative coating herein is designed to be a sacrificial coating where the cured bulk releases heat during ablation in the form of an oxidized silica “ash”. The rate of bulk loss is therefore greater for such a sacrificial coating than it is for an intumescent ablative which are formulated with unique fibers to aid in char formation and more importantly char retention. The presence of such fibres forms a network within the cured bulk and the resultant char layer is more brittle and durable compared with the surface char produced by the ablative coating described herein. Typically, the silicone ablative coatings described herein are generally utilised for a single ablative action such as the launch of a rocket and will need to be replaced for each launch or the like. In order to function successfully as an ablative, the coating provided herein will, when coated to about 4.8 to 5 mm on a ceramic tile and exposed to a temperature between 3000-3500° C. for up to 30 seconds by exposure to an acetylene-oxygen torch, preferably have an ablation penetration rate of between 0.1-10 mm per second, determined by taking thickness measurements using a set of calipers before and after the heat exposure. The difference between before and after was then divided by exposure time to deliver the penetration rate. Similarly, it should have a bulk weight loss of between 0.1-10 g per second measured by determining the weight of the coating before and after a predetermined exposure period to the acetylene-oxygen torch e.g., 10 seconds to determine rate of weight loss. Similarly, a ceramic tile substrate treated with an ablative coating using the coating composition as described herein should survive an exposure period of between 1-20 seconds, alternatively 5 and 20 seconds, alternatively 7.5 and 20 seconds.

The one-part room temperature curable and sprayable ablative silicone compositions herein preferably attain one or more of the following:
(1) having cure in depth in 24 hours of between 0.25 cm to 0.6 cm;
(2) being sprayable i.e., having the ability to be spray coated using a suitable spray apparatus
(3) having a stable viscosity upon aging, i.e., wherein the viscosity after aging at 50° C. for 2 weeks is less than 2 times of original viscosity therefore enabling the ablative coating composition to be pumpable through an acceptably sized hose system without premature cure or the like e.g. through a long main hose e.g. a hose which is at least 6m long and about 1 cm diameter as well as through a suitable lightweight whip hose used between the aforementioned main coating hose and the spray gun.
(4) having an acceptably long shelf-life at room temperature for application by said spraying operation, e.g., at least 6 alternatively at least 9 months.
(5) having no solvent or diluent included in the one-part room temperature curable and sprayable ablative silicone composition, i.e., there are no volatile organic compounds (VOCs) in the one-part room temperature curable and sprayable ablative silicone composition (other than trace impurities);
(6) being sufficiently thixotropic for both horizontal and vertical applications, i.e., no unacceptable levels of flow/slump after a single spray coating event of from 2.5 to 5 mm, e.g., a range of from 2.5 mm to 4.45 mm.

From a cure perspective these one-part room temperature curable and sprayable ablative silicone compositions have the advantage, compared to hydrosilylation compositions, in that they cure at room temperature and adhere to substrates at room temperature. They are also more resistant to contaminants than hydrosilylation cured silicones which use platinum group-based catalysts. Furthermore, given the one-part room temperature curable and sprayable ablative silicone composition does not contain any tin-based catalysts they do not undergo reversion after cure at elevated temperatures.

The one-part room temperature curable and sprayable ablative silicone composition utilised herein comprises components (a) to (e) as mentioned above, each of which is discussed below in more detail.

### Organopolysiloxane (a)

Organopolysiloxane (a) has the structure

D—Z—(R¹)_{y}SiO_{(4-y)/2})_{z}—SiR¹₂—Z—D

wherein D is either:
(i) —Si—RₙX₃₋ₙ or
(ii) —Si(R¹)₂—O—Si(R¹)(O—Si(R¹)₂—Z¹—Si—RₙX₃₋ₙ)₂
   wherein each R¹ is the same or different and is an alkyl group, alkenyl group or aryl group, each Z and Z¹ is a divalent organic group, the average value of y is between from 1.8 to 2.2, z is the number average degree of polymerization and is an integer of at least 50, each X is a hydroxyl group or alkoxy group, each R is individually selected from an alkyl group, an aminoalkyl group, polyaminoalkyl group, an epoxyalkyl group, an alkenyl group or an aromatic group and n is 0, 1 or 2.

Each R¹ is the same or different and is an alkyl group, alkenyl group or aryl group; alternatively, R¹ may be selected from an alkyl group having from 1 to 6 carbons, an alkenyl group having from 2 to 6 carbons or an aryl group having from 6 to 12 carbons groups alternatively, R¹ may be selected from methyl, ethyl, octyl, trifluoropropyl, vinyl and phenyl groups.

Each Z and Z¹ is a saturated divalent organic group, alternatively is independently an alkylene group having from 2 to 10 carbons for example ethylene (—CH₂—CH_{2—}). Each Z and Z¹ is preferably linear but may contain some branching if desired.

The average value of y is between from 1.8 to 2.2. Typically, each y is 2 (i.e., the siloxane unit is a D unit) but some branching may occur i.e., where y is 3 (T units) or y is 4 (Q units). Siloxy units may be described by a shorthand (abbreviated) nomenclature, namely—“M,” “D,” “T,” and “Q”, when R′ is an organic group e.g., a methyl group The M unit corresponds to R′₃SiO_{1/2}; the D unit corresponds to a siloxy unit R′₂SiO_{2/2}; the T unit corresponds to a siloxy unit where R₁SiO_{3/2}; the Q unit corresponds to a siloxy unit SiO_{4/2}.

Subscript z is the number average degree of polymerization and is an integer of at least 50. The Degree of Polymerization (DP) in a macromolecule or polymer or oligomer molecule of silicone, in this case organopolysiloxane (a) is usually defined as z herein the number of repeating monomeric units in a macromolecule or polymer or oligomer molecule of e.g., in this case organopolysiloxane (a). Synthetic polymers invariably consist of a mixture of macromolecular species with different degrees of polymerization and therefore of different molecular weights. There are different types of average polymer molecular weight, which can be measured in different experiments. The two most important are the number average molecular weight (Mₙ) and the weight average molecular weight (Mw). The Mₙ and Mw values of silicone can be determined by Gel permeation chromatography GPC). This technique is standard and yields Mw (weight average molecular weight), Mn (number average molecular weight) and the polydispersity index (PI). DP=Mn/Mu where Mn is the number-average molecular weight coming from the GPC measurement using triple detection and polystyrene calibration standards. Mu is the molecular weight of a monomer unit. PI=Mw/Mn. The higher the DP, the higher the viscosity.

The value of z (i.e., approximately the number average degree of polymerization) is usually significantly greater than 50 and is typically a value which places organopolysiloxane (a) within the desired viscosity range, for example z can be at least 200, alternatively in a range between 200 and 1500, alternatively a range of 200 and 1000, alternatively a range of from 200 to 700. It may be calculated from determining the number average molecular weight (Mn) values using gel permeation chromatography (GPC) e.g., for example by using a Waters 2695 Separations Module equipped with a vacuum degasser, and a Waters 2414 refractive index detector (Waters Corporation of MA, USA). The analyses were performed using certified grade toluene flowing at 1.0 mL/min as the eluent, using polystyrene calibration standards. Data collection and analyses were performed using Waters Empower™ GPC software (Waters Corporation of MA, USA).

Each X group may be the same or different and can be a hydroxyl group or alkoxy group.

Illustrative alkoxy groups are methoxy, ethoxy, propoxy, butoxy, isobutoxy, pentoxy, hexoxy and 2-ethylhexoxy; dialkoxy radicals, such as methoxymethoxy or ethoxymethoxy and alkoxyaryloxy, such as ethoxyphenoxy. The most preferred alkoxy groups are methoxy or ethoxy. Preferably each X is an alkoxy group.

Each R is individually selected from an alkyl group, an aminoalkyl group, polyaminoalkyl group, an epoxyalkyl group, an alkenyl group or an aromatic group, alternatively an alkyl group having from 1 to 12 carbons; and alkenyl group having from 2 to 12 carbons or an aromatic group having from 6 to 12 carbons; alternatively, each R is selected from methyl, ethyl, octyl, vinyl, allyl and phenyl groups.

Subscript n is 0, 1 or 2 alternatively 0 or 1, alternatively 0.

Organopolysiloxane (a) may be present in an amount of from 35 to 60% by weight of the composition, alternatively from 35 to 55% by weight of the composition.

### Precipitated Calcium Carbonate (b)

The precipitated calcium carbonate (b) is any suitable precipitated calcium carbonate having a BET surface area of at least 15 m²/g which may be hydrophobically treated and functions within the composition as a reinforcing filler. Typically, the surface area of the precipitated calcium carbonate (b) is at least 15 m²/g measured in accordance with the BET method in accordance with ISO 9277: 2010, alternatively 15 to 50 m²/g, alternatively, 15 to 25 m²/g. Typically, the precipitated calcium carbonate (b) is present in the one-part room temperature curable and sprayable ablative silicone composition in an amount of from about 5 to 25 wt. % of the composition, alternatively from about 5 to 20 wt. % of the composition, providing that the cumulative wt. % of components (b) and (c) is from 40 to 60 wt. % of the composition and the weight ratio of precipitated calcium carbonate (b) to the one or more non-fibrous, non-reinforcing fillers, (c) is from 1:2 to 1:7.

The precipitated calcium carbonate reinforcing fillers (b) may be hydrophobically treated for example with one or more aliphatic acids, e.g., a fatty acid such as stearic acid or a fatty acid ester such as a stearate, or with organosilanes, organosiloxanes, or organosilazanes e.g., hexaalkyl disilazane or short chain siloxane diols to render the filler(s) (b) hydrophobic and therefore easier to handle and obtain a homogeneous mixture with the other adhesive components. The surface treatment of the fillers makes them easily wetted by organopolysiloxane (a). These surface modified fillers do not clump and can be homogeneously incorporated into organopolysiloxane (a). This results in improved room temperature mechanical properties of the one-part room temperature curable and sprayable ablative silicone compositions. The fillers may be pre-treated or may be treated in situ when being mixed with organopolysiloxane (a).

### Non-Fibrous Non-Reinforcing Fillers (c)

Such fillers considered to have a low aspect ratio (the ratio of length to diameter) of from 1 to 10 (this may be measured using transmission electron microscopy but herein is generally identified from reference books or supplier data) and may include, for the sake of example, silicates such as zeolite, sericite, kaolin, mica, clay, bentonite, asbestos, talc, and alumina silicate, alumina, metal compounds such as magnesium oxide, zirconium oxide, titanium oxide, and iron oxide, ground calcium carbonate magnesium carbonate, dolomite, sulfates such as calcium sulfate and barium sulfate, glass flakes, glass beads, ceramic beads, mica, boron nitride and silicon carbide.

Whenever deemed necessary the one or more non-fibrous, non-reinforcing fillers, (c) may also be treated as described above with respect to the reinforcing fillers (b) to render them hydrophobic and thereby easier to handle and obtain a homogeneous mixture with the other components. As in the case of the reinforcing fillers (b) surface treatment of the non-reinforcing fillers makes them easily wetted by organopolysiloxane (a). Preferably the non-fibrous, non-reinforcing filler (c) is ground calcium carbonate. For the avoidance of doubt a non-reinforcing filler is typically a low-cost ingredient which is often used to reduce the overall cost of the material. Whilst its presence may provide some improvement in mechanical properties this is far less than a reinforcing filler will contribute.

The cumulative wt. % of components (b) and (c) is from 40 to 60 wt. % of the one-part room temperature curable and sprayable ablative silicone composition, alternatively from 45 to 60 wt. % of the composition and the weight ratio of precipitated calcium carbonate (b): the one or more non-fibrous, non-reinforcing fillers, (c) is from 1:2 to 1:7.

In one embodiment the one or more non-fibrous, non-reinforcing fillers, (c) comprises or consists of ground calcium carbonate. Hence, when the one or more non-fibrous, non-reinforcing fillers, (c) consists of ground calcium carbonate the weight ratio of precipitated calcium carbonate (b): ground calcium carbonate is from 1:2 to 1:7.

### Silane Cross-Linker (d)

Silane cross-linker (d) has the structure

R⁷_{c}—Si—R⁶_{4-c}

wherein each R⁷ is an alkoxy group having from 1 to 10 carbons, a ketoximino group or an alkenyloxy group; each R⁶ is selected from is a non-hydrolysable silicon-bonded organic group, and c is 2, 3 or 4.

Cross-linker (d) utilized herein has the structure R⁷_{c}—Si—R⁶_{4-c} wherein each R⁷ is an alkoxy group having from 1 to 10 carbons, each R⁶ is selected from is a non-hydrolysable silicon-bonded organic group, and c is 2, 3 or 4.

Each R⁷ may for example be an alkoxy group having from one to 10 carbons, alternatively methoxy, ethoxy, propoxy iso-propoxy, butoxy, t-butoxy, pentoxy (amyloxy), isopentoxy (isoamyloxy), hexoxy and isohexoxy; alternatively, methoxy, ethoxy, propoxy; a ketoximino group (for example dimethyl ketoximo, and isobutylketoximino); or an alkenyloxy groups (for example isopropenyloxy and 1-ethyl-2-methylvinyloxy). In one embodiment all R⁷ groups present are the same and are preferably all alkoxy groups, especially methoxy or ethoxy groups, alternatively methoxy groups Each R⁶ group may be any suitable non-hydrolysable silicon-bonded organic group, such as an alkyl group having from 1 to 6 carbons (for example methyl, ethyl, propyl, and butyl); an alkenyl group having from 2 to 6 carbons, (for example vinyl and allyl) cycloalkyl groups (for example cyclopentyl and cyclohexyl); aryl groups (for example phenyl, and tolyl); aralkyl groups (for example 2-phenylethyl).

It will be seen that subscript c maybe 2, 3 or 4. Typically, crosslinker (d) may only function as a cross-linker when subscript c is 2 if, organopolysiloxane (a) comprises more than two —OH or hydrolysable groups per molecule otherwise it will solely cause chain-extension and not function as a cross-linker. Preferably subscript c is either 3 or 4 for cross-linking purposes but it is to be understood that in some cases, it is desirable to include a fraction of di(alkoxy) functional silanes (c=2) in a mixture with tri or tetrafunctional alkoxysilanes (c=3 or 4) to impart chain-extension and flexibility.

Silanes which can be used as cross-linkers (d) include bis (trimethoxysilyl)hexane, 1,2-bis (triethoxysilyl)ethane, alkyltrialkoxysilanes such as methyltrimethoxysilane (MTM) and methyltriethoxysilane, alkenyltrialkoxy silanes such as vinyltrimethoxysilane and vinyltriethoxysilane, isobutyltrimethoxysilane (iBTM). Other suitable silanes include ethyltrimethoxysilane, phenyltrimethoxysilane, 3,3,3-trifluoropropyltrimethoxysilane, tetramethoxysilane, tetraethoxysilane (tetraethyl orthosilicate), tetrapropoxysilane (tetrapropyl orthosilicate) and tetrapentoxysilane (tetraamyl orthosilicate); or alternatively alkoxytrioximosilane, alkenyltrioximosilane, methyltris(methylethylketoximo)silane, vinyl-tris-methylethylketoximo)silane, methyltris(methylethylketoximino)silane, alkenyl alkyl dialkoxysilanes such as vinyl methyl dimethoxysilane, vinyl ethyldimethoxysilane, vinyl methyldiethoxysilane, vinylethyldiethoxysilane, alkenylalkyldioximosilanes such as vinyl methyl dioximosilane, vinyl ethyldioximosilane, vinyl methyldioximosilane, vinylethyldioximosilane and/or methylphenyl-dimethoxysilane. In one embodiment the cross-linker comprises or consists of methyltrimethoxysilane. The cross-linker (d) used may also comprise any combination of two or more of the above. The composition may comprise from 1 to 15 wt. % of cross-linker (d), alternatively 1.5 to 15 wt. % of cross-linker (d), alternatively 1.75 to 10 wt. % of cross-linker (d).

### Titanate or a Zirconate Condensation Reaction Catalyst (e)

The titanate or zirconate condensation reaction catalyst (e) may be selected from a titanate or a zirconate. The titanate and/or zirconate-based catalysts (e) may comprise a compound according to the general formula Ti[OR²²]₄ or Zr[OR²²]₄ where each R²² may be the same or different and represents a monovalent, primary, secondary or tertiary alkyl group which may be linear or branched containing from 1 to 10 carbon atoms. Optionally the titanate and/or zirconate may contain partially unsaturated groups. Examples of R²² include but are not restricted to methyl, ethyl, propyl, isopropyl, butyl, tertiary butyl and a branched secondary alkyl group such as 2, 4-dimethyl-3-pentyl. Alternatively, when each R²² is the same, R²² is an isopropyl, branched secondary alkyl group or a tertiary alkyl group, in particular, tertiary butyl. Suitable titanate examples include tetra n-butyl titanate, tetra t-butyl titanate, titanium tetrabutoxide and tetraisopropyl titanate. Suitable zirconate examples include tetra-n-propyl zirconate, tetra-n-butyl zirconate and zirconium diethylcitrate. Alternatively, the titanate and/or zirconate may be chelated. The chelation may be with any suitable chelating agent such as an alkyl acetylacetonate such as methyl or ethylacetylacetonate. Alternatively, the titanate may be monoalkoxy titanates bearing three chelating agents such as for example 2-propanolato, tris isooctadecanoato titanate or diisopropyldiethylacetoacetate titanate. Alkoxy titanium compounds and alkoxy zirconium compounds, preferably the former are suitable catalysts for curing one component moisture curable silicone compositions via skin or diffusion cure mechanisms. They are typically available in one-part compositions that are applied in a layer that is thinner than typically 15 mm (as layers thicker than 15 mm are known to lead to uncured material in the depth of the material). Skin or diffusion cure (e.g., moisture/condensation) takes place by the formation of a cured skin at the composition/air interface subsequent to the sealant/encapsulant being applied on to a substrate surface. Subsequent to the generation of the surface skin the cure speed is dependent on the speed of diffusion of moisture from the sealant/encapsulant interface with air to the inside (or core), and the diffusion of condensation reaction by-product/effluent from the inside (or core) to the outside (or surface) of the material and the gradual thickening of the cured skin over time from the outside/surface to the inside/core.

The catalyst (e) will be present in the composition in a suitably catalytic amount for example from about 0.2 to 2 weight % of the composition.

### Optional Additives

The one-part room temperature curable and sprayable ablative silicone composition described herein may also include one or more optional additives. These may include but are not restricted to plasticisers/extenders, adhesion promoters, chain extenders pigments, rheology modifiers; heat stabilizers, flame retardants, UV stabilizers, and fungicides and/or biocides and the like.

### Plasticisers/Extenders

The one-part room temperature curable and sprayable ablative silicone composition may comprise one or more liquid plasticizers/extenders (sometimes referred to as processing aids) in the form of a silicone or organic fluid which is unreactive with all of components (a) to (e) described above. Examples of non-reactive silicone fluids useful as plasticizers which may be incorporated into the one-part room temperature curable and sprayable ablative silicone composition include polydiorganosiloxanes such as polydimethylsiloxane having terminal triorganosiloxy groups wherein the organic substituents are, for example, methyl, vinyl or phenyl or combinations of these groups. Such polydimethylsiloxanes can for example have a viscosity of from about 5 to about 100,000 mPa·s at 25° C.

Alternatively compatible organic plasticisers may be utilised additionally to or instead of the silicone fluid plasticiser include dialkyl phthalates wherein the alkyl group may be linear and/or branched and contains from six to 20 carbon atoms such as dioctylphthalate, dihexylphthalate, dinonylphthalate, didecylphthalate, and other phthalates, and analogous adipate, azelate, oleate and sebacate esters; polyols such as ethylene glycol and its derivatives; and organic phosphates such as tricresyl phosphate and/or triphenyl phosphates may also be used if compatible with the composition.

Examples of extenders for use in the one-part room temperature curable and sprayable ablative silicone compositions herein include mineral oil based (typically petroleum based) paraffinic hydrocarbons, mixtures of paraffinic and naphthenic hydrocarbons, paraffin oils comprising cyclic paraffins and non-cyclic paraffins and hydrocarbon fluids containing naphthenics, polycyclic naphthenics and paraffins, or polyalkylbenzenes such as heavy alkylates (alkylated aromatic materials remaining after distillation of oil in a refinery). Examples of such extenders are discussed in GB2424898 the content of which is hereby enclosed by reference.

If present the plasticizer or extender content will be present in an amount of from >0 to 10% by weight of the composition.

### Adhesion Promoter

Suitable adhesion promoters may comprise alkoxysilanes of the formula R¹⁴ₕSi(OR¹⁵)₍₄₋ₕ), where subscript h is 1, 2, or 3, alternatively h is 3. Each R¹⁴ is independently selected from an epoxy functional group such as glycidoxypropyl or (epoxycyclohexyl)ethyl, an amino functional group such as aminoethylaminopropyl or aminopropyl, a methacryloxypropyl, a mercapto functional group such as mercaptopropyl or an unsaturated organic group. Each R¹⁵ is independently an unsubstituted, saturated hydrocarbon group of at least 1 carbon atom. R¹⁵ may have 1 to 4 carbon atoms, alternatively 1 to 2 carbon atoms. R¹⁵ is exemplified by methyl, ethyl, n-propyl, and iso-propyl. Examples of suitable adhesion promoters include glycidoxypropyltrimethoxysilane and a combination of glycidoxypropyltrimethoxysilane with an aluminium chelate or zirconium chelate; aminoalkylalkoxysilanes, for example 3-aminopropyltriethoxysilane, epoxyalkylalkoxysilanes, for example, 3-glycidoxypropyltrimethoxysilane and, mercapto-alkylalkoxysilanes, and reaction products of ethylenediamine with silylacrylates. Isocyanurates containing silicon groups such as 1, 3, 5-tris(trialkoxysilylalkyl) isocyanurates may additionally be used. Further suitable adhesion promoters are reaction products of epoxyalkylalkoxysilanes such as 3-glycidoxypropyltrimethoxysilane with amino-substituted alkoxysilanes such as 3-aminopropyltrimethoxysilane and optionally with alkylalkoxysilanes such as methyltrimethoxysilane.

Alternatively, the adhesion promoter may be a diaminosilane adhesion promoter of the structure in accordance with the formula:

R⁴ₜ(R′O)₃₋ₜSi—Z²—N(H)—(CH₂)ₘ—NH₂

in which R⁴ is an alkyl group containing from 1 to 10 carbon atoms, alternatively R⁴ is an alkyl group containing from 1 to 6 carbon atoms, alternatively, R⁴ is a methyl or ethyl group. Each R′ may be the same or different and is each R′ may be the same or different and is H or R⁴, alternatively each R′ is R⁴. In one alternative the two R′ groups are the same. When the two R′ groups are the same, it is preferred that they are methyl or ethyl groups. Z² is a linear or branched alkylene group having from 2 to 10 carbons, alternatively from 2 to 6 carbons, for example Z² may be a propylene group, a butylene group or an isobutylene group. Subscript m may be from 2 to 10, in one alterative m may be from 2 to 6, in another alternative m may be from 2 to 5, in a still further alternative m may be 2 or 3, alternatively m is 2. An example thereof being N-(3-(Trimethoxysilyl) propyl)-1,2-ethanediamine. When present adhesion promoters will be present in an amount of from 0.01% to 2 wt. %, alternatively 0.05 to 2 wt. %., alternatively 0.05 to 1.5 wt. % based on the weight of the one-part room temperature curable and sprayable ablative silicone composition.

### Chain Extenders

Chain extenders may include difunctional silanes which extend the length of the polysiloxane polymer chains before cross linking occurs and, thereby, reduce the modulus of elongation of the cured elastomer. Chain extenders and crosslinkers compete in their reactions with the functional polymer ends; in order to achieve noticeable chain extension, the difunctional silane must have substantially higher reactivity than the trifunctional crosslinker with which it is used. Suitable chain extenders include diamidosilanes such as dialkyldiacetamidosilanes or alkenylalkyldiacetamidosilanes, particularly methylvinyldi(N-methylacetamido)silane, or dimethyldi(N-methylacetamido)silane, diacetoxysilanes such as dialkyldiacetoxysilanes or alkylalkenyldiacetoxysilanes, diaminosilanes such as dialkyldiaminosilanes or alkylalkenyldiaminosilanes, dialkoxysilanes such as dimethoxydimethylsilane, diethoxydimethylsilane and α-aminoalkyldialkoxyalkylsilanes, polydialkylsiloxanes having a degree of polymerization of from 2 to 25 and having at least three acetamido or acetoxy or amino or alkoxy or amido or ketoximo substituents per molecule, and diketoximinosilanes such as dialkylkdiketoximinosilanes and alkylalkenyldiketoximinosilanes.

### Pigments

The one-part room temperature curable and sprayable ablative silicone composition as described herein may further comprise one or more pigments and/or colorants which may be added if desired. The pigments and/or colorants may be coloured, white, black, metal effect, and luminescent e.g., fluorescent and phosphorescent. Pigments are utilized to colour the one-part room temperature curable and sprayable ablative silicone composition as required. Any suitable pigment may be utilized providing it is compatible with the composition herein. In the one-part room temperature curable and sprayable ablative silicone compositions pigments and/or coloured (non-white) fillers e.g., carbon black may be utilized in the composition to colour the ablative coating if desired. Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminium, copper, copper oxide, bronze, stainless steel, nickel, zinc, and brass. Suitable organic non-white pigments and/or colorants include phthalocyanine pigments, e.g. phthalocyanine blue and phthalocyanine green; monoarylide yellow, diarylide yellow, benzimidazolone yellow, heterocyclic yellow, DAN orange, quinacridone pigments, e.g. quinacridone magenta and quinacridone violet; organic reds, including metallized azo reds and nonmetallized azo reds and other azo pigments, monoazo pigments, diazo pigments, azo pigment lakes, β-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

### Rheology Modifiers

Rheology modifiers which may be incorporated in the one-part room temperature curable and sprayable ablative silicone composition include silicone organic co-polymers such as those described in EP 0802233 based on polyols of polyethers or polyesters; non-ionic surfactants selected from the group consisting of polyethylene glycol, polypropylene glycol, ethoxylated castor oil, oleic acid ethoxylate, alkylphenol ethoxylates, copolymers or ethylene oxide and propylene oxide, and silicone polyether copolymers; as well as silicone glycols. For some systems these rheology modifiers, particularly copolymers of ethylene oxide and propylene oxide, and silicone polyether copolymers, may enhance the adhesion of the sealant to substrates.

### Heat Stabilizers

Examples of heat stabilizers include metal compounds such as red iron oxide, yellow iron oxide, ferric hydroxide, cerium oxide, cerium hydroxide, lanthanum oxide, copper phthalocyanine, aluminum hydroxide, fumed titanium dioxide, iron naphthenate, cerium naphthenate, cerium dimethylpolysilanolate and acetylacetone salts of a metal chosen from copper, zinc, aluminum, iron, cerium, zirconium, titanium and the like. The amount of heat stabilizer when present in the one-part room temperature curable and sprayable ablative silicone composition may range from 0.01 to 1.0% weight of the composition.

### Flame Retardants

Flame retardants may include aluminium trihydroxide and magnesium dihydroxide, iron oxides, triphenyl phosphate, dimethyl methylphosphonate, tris(2,3-dibromopropyl) phosphate (brominated tris), halogenated flame retardants such as chlorinated paraffins and hexabromocyclododecane, and mixtures or derivatives thereof.

### Antioxidants

Any suitable antioxidant(s) may be utilized, if deemed required. Examples may include: ethylene bis (oxyethylene) bis(3-tert-butyl-4-hydroxy-5(methylhydrocinnamate) 36443-68-2; tetrakis[methylene(3,5-di-tert-butyl-4-hydroxy hydrocinnamate)]methane 6683-19-8; octadecyl 3,5-di-tert-butyl-4-hydroxyhyrocinnamate 2082-79-3; N,N′-hexamethylene-bis (3,5-di-tert-butyl-4-hydroxyhyrocinnamamide) 23128-74-7; 3,5-di-tert-butyl-4-hydroxyhydrocinnamic acid,C7-9 branched alkyl esters 125643-61-0; N-phenylbenzene amine, reaction products with 2,4,4-trimethylpentene 68411-46-1; e.g. anti-oxidants sold under the Irganox™ name from BASF.

### UV and/or Light Stabilizers

UV and/or light stabilizers may include, for the sake of example include benzotriazole, ultraviolet light absorbers and/or hindered amine light stabilizers (HALS) such as the TINUVIN™ product line from Ciba Specialty Chemicals Inc.

### Biocides

Biocides may additionally be utilized in the one-part room temperature curable and sprayable ablative silicone composition if required. It is intended that the term “biocides” includes bactericides, fungicides and algicides, and the like. Suitable examples of useful biocides which may be utilized in the one-part room temperature curable and sprayable ablative silicone composition include, for the sake of example:

Carbamates such as methyl-N-benzimidazol-2-ylcarbamate (carbendazim) and other suitable carbamates, 10, 10′-oxybisphenoxarsine, 2-(4-thiazolyl)-benzimidazole, N-(fluorodichloromethylthio)phthalimide, diiodomethyl p-tolyl sulfone, if appropriate in combination with a UV stabilizer, such as 2,6-di(tert-butyl)-p-cresol, 3-iodo-2-propinyl butylcarbamate (IPBC), zinc 2-pyridinethiol 1-oxide, triazolyl compounds and isothiazolinones, such as 4,5-dichloro-2-(n-octyl)-4-isothiazolin-3-one (DCOIT), 2-(n-octyl)-4-isothiazolin-3-one (OIT) and n-butyl-1,2-benzisothiazolin-3-one (BBIT). Other biocides might include for example Zinc Pyridinethione, 1-(4-Chlorophenyl)-4,4-dimethyl-3-(1,2,4-triazol-1-ylmethyl)pentan-3-ol and/or 1-[[2-(2,4-dichlorophenyl)-4-propyl-1,3-dioxolan-2-yl]methyl]-1H-1,2,4-triazole.

Hence, the one-part room temperature curable and sprayable ablative silicone composition may comprise a suitable combination of:
Organopolysiloxane (a) in an amount of from 35 to 60% by weight of the composition, alternatively from 35 to 55% by weight of the composition;
Precipitated calcium carbonate (b) and non-fibrous, non-reinforcing fillers, (c), preferably ground calcium carbonate, where the cumulative wt. % of components (b) and (c) is from 40 to 60 wt. % of the one-part room temperature curable and sprayable ablative silicone composition, alternatively from 45 to 60 wt. % of the composition and the weight ratio of precipitated calcium carbonate (b): the one or more non-fibrous, non-reinforcing fillers, (c) is from 1:2 to 1:7;
Silane cross-linker (d) in an amount of from 1 to 15 wt. % of the composition, alternatively 1.5 to 15 wt. % of the composition, alternatively 1.75 to 10 wt. % of the composition; and
titanate or a zirconate condensation reaction catalyst (e) in a suitably catalytic amount for example from about 0.2 to 2 weight % of the composition.

The one-part room temperature curable and sprayable ablative silicone composition may additionally comprise one or more of the additives identified above but the total weight % of any composition is 100 wt. %.

Preferably the one-part room temperature curable and sprayable ablative silicone composition once prepared under high shear in a high shear mixer has a viscosity of between 40 Pa·s and 125 Pa·s, alternatively between 40 Pa·s and 100 Pa·s, using a Brookfield™ DV-II+Pro Programmable viscometer using spindle 7 at a shear rate of 10 rpm measured at 25° C.

The thixotropic curable coating on the substrate is made from the one-part room temperature curable and sprayable ablative silicone composition after it has been mixed under high shear and is provided with a coating thickness before any visible indication of slump/flow/creep of from 2.5 to 5 mm depth, alternatively of from 2.5 to 4.45 mm depth measured using a wet film comb gauge. (For the avoidance of doubt, wet film comb gauges are also known as notch gauges. They are formed on the edge of a piece of material so that each notch has a different clearance from the reference shoulders to its neighbors and are used to determine film thicknesses.)

The method for providing a substrate with an ablative coating as described herein comprises the following steps
(I) Preparing the one-part room temperature curable and sprayable ablative silicone composition as described above by mixing in a suitable high shear mixer; supplying the resulting mixture of step (I) i.e., a one-part room temperature curable and sprayable ablative silicone composition to a spray gun via suitable hose arrangement. The one-part room temperature curable and sprayable ablative silicone composition resulting from step (I) has an extrusion Rate of 1900 to 2600 g/min when measured in accordance with ASTM C1183
(II) spraying the resulting mixture of step (I) onto a substrate surface to produce a thixotropic curable coating on the substrate which has a coating thickness before any visible indication of slump/flow/creep of from 2.5 to 5 mm measured using a wet film comb gauge, and
(III) allowing the composition to cure at room temperature.

The one-part room temperature curable and sprayable ablative silicone composition resulting from the high shear mixing of step (I) has an extrusion Rate of from 1900 to 2600 g/min, alternatively an extrusion Rate of 1900 to 2500 g/min when measured in accordance with ASTM C1183.

The one-part room temperature curable and sprayable ablative silicone composition is prepared using a suitable high shear mixer such as for example a twin-screw extruder, as well as high shear batch mixers such as planetary mixers and kneader type mixers. The one-part room temperature curable and sprayable ablative silicone composition herein is designed to be sprayable through a spray gun after being pumped thereto and as such needs to have a low enough viscosity to be pumpable through a hose arrangement etc. and to be sprayable using any suitable technique and is designed to be applied to form a single layer which is sufficiently thixotropic to be of a suitable thickness e.g., from 2.5 mm to 5 mm, alternatively 2.5 mm to 4.45 mm thickness without any significant flow if applied onto the substrate either horizontally or vertically.

The amounts of the ingredients used in the composition described herein are chosen so that, despite being titanate and/or zirconate cured, the coating will cure in depth at room temperature within 24 hours at room temperature. This is much quicker than many one-part compositions using such catalysts and may be partially due to the reactivity of organopolysiloxane (a).

It was found in step (I) that by high shear mixing the components previously described herein a one-part room temperature curable and sprayable ablative silicone composition is produced having a viscosity within the suitable range discussed above allowing the composition to be pumped through a suitable hose system to a spray gun or applicator and then may be applied onto a target substrate in step (II). Furthermore, being prepared using a high shear mixer in step (I) results in a much more thixotropic coating being attained after application on to the substrate surface.

The hose system may comprise a main hose of a suitable length and diameter such as a minimum length of about 6 m and a diameter of about 1 cm to 1.5 cm and if desired a more easily handled whip type hose linking the main hose to the spray gun/applicator and making the spray gun/applicator easier to operate and apply the silicone ablative coating onto the desired substrate surface. The whip type hose might be for example 2 or 3 meters in length and be of a similar but typically a narrower diameter e.g., between 0.5 cm and 1 cm. In one embodiment the minimum pressure at the spray gun was at least 3800 psig, (26.2 MPa), alternatively 4000 psig (27.58 MPa).

The one-part room temperature curable and sprayable ablative silicone composition provided herein can be applied using any suitable spraying technique. For example, it may be applied onto a substrate surface in the form of a fine airless atomised spray with the resulting spray droplets coalescing on the substrate surface to form a continuous film and to gradually build in thickness. Alternatively, the ablative coating composition can be applied via a texture type spray gun where a much thicker coating is sprayed (or sputtered) onto the substrate surface. It will be appreciated that if desired the user may apply the one-part room temperature curable and sprayable ablative silicone composition by alternative means e.g., by being rolled, troweled, painted or even dip coated, but given the substrates of interest for such coatings it is believed spray coating is particularly beneficial.

The ablative coating composition as described herein is preferably applied onto a pre-cleaned substrate surface, e.g., with a suitable solvent that will remove oils, and other contaminants that may be present. Furthermore, if desired or preferred the substrate to be treated with the coating composition described herein may be pre-treated with a suitable primer which can increase substrate surface energy and material wetting and consequently improve adhesion. Any suitable primer may be utilised, for example DOWSIL™ 1200 RTV Prime Coat commercially available from Dow Silicones Corporation. When utilised said primer should be applied in a very light, even coat by wiping, dipping, or spraying onto a pre-cleaned substrate surface. Mild heat can be used to accelerate the rate of cure for primers. It was typically found that, especially in the case of application by spraying, the ablative coating composition as described herein did not generally require the pre-treatment of the substrate with such primers because the composition provides primerless adhesion to most substrate. Indeed, the use of such primers should not provide any significant improvement in the ablative adhesion profile of the ablative composition as herein before described to the substrate surface after priming on both steel and concrete substrates. In each instance, adhesion results should be very similar after applying the ablative composition onto primed and unprimed substrate surfaces and in all four instances the results between 0.35 kN/m and 5.25 kN/m in accordance with Dow silicones Corporation corporate test method (CTM) 0293 which is available to the public upon request.

Irrespective of the manner in which the coating is applied, the composition is designed to form a thixotropic coating on the substrate surface of a suitable thickness for said ablative coating. The thixotropic nature of the coating is observed almost immediately upon application allowing the coating to build to a thickness of from e.g., 2.5 mm to 5 mm, alternatively 2.5 mm to 4.45 mm thickness without any significant flow/slump/creep effects are observed. The ability to provide such a coating thickness in one application and indeed not to lose a significant amount of the coating depth upon cure provides a significant advantage over prior ablative coating compositions relying on a dilution effect to enable sprayability. This is particularly the case when one considers whilst cure may be slower than other systems for a single coating layer, diluted coatings require several coatings to be applied and approximately 12 hours between each coating application and as such can require several days to complete the coating process. The present coating compositions can provide the user with a working time of up to 45 minutes, e.g., from 10 to 45 minutes, alternatively 10 to 30 minutes, alternatively 10 to 25 minutes alternatively 10 to 20 minutes. The working time will tend to be shorter when the coating composition is sprayed onto the substrate when the coating thickness can be significantly thinner than via other methods of application. However, if sprayed well onto the substrate surface such coatings should not really require a work time, unlike when applied by other methods e.g., by trowelling. Hence, the present coating compositions can provide relatively short skin over time (i.e., the point in time when no uncured ablative composition transfers when touched) of from 10 to 45 minutes, alternatively less than 30 minutes, e.g., 10 to 30 minutes, alternatively 10 to 25 minutes alternatively 10 to 20 minutes. The skin over time is often slightly shorter than the tack free time as the skin may remain slightly tacky for a short period after the skin over time has been met. The composition herein provides a suitable cure in depth after a 24-hour period.

The ablative coatings made from the one-part room temperature curable and sprayable ablative silicone compositions as described herein may be used to coat any suitable substrate which is subjected to high-heat, direct or indirect flame impingement and/or significant friction (i.e., hypersonic missiles). As previously discussed, articles of which the substrates form a part may include aerospace vehicles, rocket parts such as nozzle units, combustion chambers and engine casings, re-entry space vehicles, missile parts such as missile nose cones, missile and rocket launch pads aircraft parts, heat shields and/or other articles containing an important structural member associated with the heat producing devices such as steel structures, cement trenches.

### EXAMPLES

All viscosity measurements were made using a Brookfield™ DV-II+Pro Programmable viscometer using spindle 7 at a shear rate of 10 rpm unless otherwise indicated. Viscosity measurements were taken at 25° C. unless otherwise indicated.

In a first series of comparative examples a series of what proved to be comparative examples were prepared.

TABLE 1
Composition of Developmental Examples 1 & 2 (D.1 & 2)
and Comparative Examples 1 to 43 (C.1-4) in wt. %

| | C.1 | C.2 | C.3 | D.1 | D.2 | C.4 |
|---|---|---|---|---|---|---|
| Polymer 1 | 43.33 | 43.33 | 42.13 | 42.43 | 42.13 | 12.73 |
| Precipitated Calcium | 18.3 | 18.3 | 30.3 | 30.0 | 30.3 | 18.9 |
| Carbonate | | | | | | |
| Ground Calcium carbonate 1 | | | 24.1 | 24.1 | 24.1 | |
| Ground Calcium Carbonate 2 | 35.8 | 35.8 | | | | 35.8 |
| Methyltrimethoxysilane | 1.3 | 1.3 | 2.5 | 2.5 | 2.5 | 1.3 |
| N-(3-(Trimethoxysilyl) | 0.07 | 0.07 | 0.07 | 0.07 | 0.07 | .07 |
| propyl)-1,2-ethanediamine | | | | | | |
| Titanate Catalyst | 1.2 | 1.2 | 0.9 | 0.9 | 0.9 | 1.2 |
| Polymer 2 | | | | | | 20.0 |
| Polymer 3 | | | | | | 10.0 |

In each case it was found that each composition was shear thinning.

The ingredients used in the compositions of Table 1 included:

Polymer 1 was a rmethoxysilylethylene terminated polydimethylsiloxane having a viscosity of 2600 mPa·s at 25° C.;

Precipitated Calcium Carbonate was ULTRA-PFLEX™ which is a hydrophobically treated precipitated calcium carbonate with a median particle size of 70 nanometers and a surface area of 19 m²/g (supplier information) commercially available from Specialty Minerals Inc.

Ground Calcium carbonate 1 was PFINYL™ 402 which is a hydrophobically treated ground calcium carbonate having an average particle size of 5.5 μm and a surface area of 2 m²/g (supplier information) commercially available from Specialty Minerals Inc.

Ground Calcium carbonate 2 was Gama-Sperse™ CS-11 which is a hydrophobically treated ground calcium carbonate having an average particle size of 3 μm and a surface area of 3.5 m²/g (supplier information) commercially available from Imerys S.A

Titanate Catalyst was Tyzor™ PITA-SM an ethyl acetoacetate complex of titanium in methyl-trimethoxy silane commercially available from Dorf Ketal Speciality Catalysts LLC;

Polymer 2 was a dimethylhydroxy terminated polydimethylsiloxane having a viscosity of 13,000 mPa·s at 25° C.; and

Polymer 3 was a trimethyl terminated polydimethylsiloxane having a viscosity of 100 mPa·s at 25° C.

The compositions depicted in Table 1 were prepared as follows:

### Comparative Example 1 (C. 1) Preparation

649.1 grams (g) of polymer 1 was mixed with 30.0 g of methyltrimethoxysilane (cross-linker), 27.6 g catalyst and 1.7 g N-(3-(Trimethoxysilyl) propyl)-1,2-ethanediamine (adhesion promoter) in the mixing vessel of 1 gallon (4.55 litres) low shear bench mixer. The mixture was mixed at 20 rpm for 3 minutes. Subsequently 439.0 g of precipitated calcium carbonate was introduced and the resultant mixture was mixed at 45 rpm for a further 5 minutes. 859.2 g ground calcium carbonate 2 was then added and the resultant mixture was mixed at 45 rpm for 5 minutes. After this the resulting mixture was further mixed at 60 rpm 10 minutes before a second addition of 393.5 g polymer 1 was added and mixed in at 60 rpm for 5 minutes. The resulting mixture was then further mixed at 60 rpm under vacuum at of 33,589 Pascals (0.336 atm) for 10 minutes. The resulting composition was then packaged into 300 mL cartridges.

### Comparative Example 2 (C. 2) Preparation

108.2 g of polymer 1, 5.0 g methyltrimethoxysilane, 4.6 g catalyst and 0.3 g N-(3-(Trimethoxysilyl) propyl)-1,2-ethanediamine were mixed together in a 400 ml dental cup at 800 rpm for 30 seconds. 73.2 g of precipitated calcium carbonate was then introduced and the resulting mixture was mixed at 2000 rpm for 30 seconds. 143.2 g of ground calcium carbonate 2 was then added and the resulting mixture was mixed mix at 2000 rpm for 30 seconds. Finally add 65.6 g polymer 1 was introduced and the resulting mixture was mixed at 2000 rpm for 30 seconds. The sample was then packaged into a 300 mL cartridge.

### Comparative Example 3 (C. 3) Preparation

649.1 g polymer 1, 60.0 g methyltrimethoxysilane, 20.4 g catalyst and 1.7 g N-(3-(Trimethoxysilyl) propyl)-1,2-ethanediamine were introduced into the mixing vessel of 1 gal low shear bench mixer and were mixed together at 20 rpm for 3 minutes. 720.0 g precipitated calcium carbonate was then introduced and the mixture was mixed at 45 rpm for 5 minutes. 578.2 g of ground calcium carbonate 1 was then introduced and mixed in at 45 rpm for 5 minutes. The mixing speed was then increased to 60 rpm and mixed for 10 minutes. Finally, a further 370.7 g polymer 1 was introduced and was mixed in at 60 rpm for 5 minutes. The mixing was then continued at 60 rpm under vacuum of 33,589 Pascals (0.336 atm) for 10 minutes. The material is then packaged into 300 mL cartridges.

### Developmental Example 1 Preparation

108.2 g polymer 1, 10.0 g methyltrimethoxysilane, 3.4 g catalyst and 0.3 g N-(3-(Trimethoxysilyl) propyl)-1,2-ethanediamine were blended together into a 400 ml dental cup and were mixed at 800 rpm for 30 seconds. 120 g of precipitated calcium carbonate was added and mixed in at 2000 rpm for 30 seconds. 96.4 g of ground calcium carbonate 1 and was then introduced and mixed in at 2000 rpm for 30 seconds. Finally add 61.8 g of polymer 1 was introduced and was mixed in at 2000 rpm for 30 seconds. The sample was then packaged into a 300 mL cartridge.

### Developmental Example 2 Preparation

649.1 g of polymer 1, 60.0 g of methyltrimethoxysilane, 20.4 g of catalyst and 1.7 g of N-(3-(Trimethoxysilyl) propyl)-1,2-ethanediamine were introduced into the mixing vessel of a 1 gallon (4.55 litres) high shear bench mixer and was mixed using a low-speed anchor blade at 50 rpm for 3 minutes. 720.0 g precipitated calcium carbonate was then introduced and mixed in at 100 rpm using the low-speed anchor blade and then at 5000 rpm using a single high-speed mixing blade for 5 minutes. 578.2 g of ground calcium carbonate 1 was then introduced and mixed in at 100 rpm using low-speed anchor blade and then 5000 rpm using the single high-speed mixing blade for 5 minutes. The mixing speed of the high-speed mixing blade was then increased to 7000 rpm and the mixture was further mixed for 20 minutes. Finally, 370.7 g of polymer 1 was introduced and mixed in at 100 rpm using low-speed mixing blade and then 4000 rpm using the single high-speed mixing blade for 5 minutes. Mixing was then continued under a vacuum of 33,589 Pascals (0.336 atm) for 10 minutes. The material is then packaged into 300 mL cartridges.

### Comparative Example 4 Preparation

480.0 g of Polymer 2, 240.0 g of polymer 3, 30.0 g of methyltrimethoxysilane, 27.6 g of catalyst and 1.7 g of N-(3-(Trimethoxysilyl) propyl)-1,2-ethanediamine into mixing vessel of 1 gallon (4.55 litres) low shear bench mixer. The mixture was mixed at 20 rpm for 3 minutes. 439.0 g of precipitated calcium carbonate was then introduced and mixed in at 45 rpm for 5 minutes. 859.2 g of ground calcium carbonate 2 was then added and mixed in at 45 rpm for 5 minutes. The mixing speed was then increased to 60 rpm and the mixture was further mixed for 10 minutes. Finally, 321.8 g of polymer 1 was introduced and mixed in at 60 rpm for 5 minutes. The composition was then further mixed at 60 rpm under vacuum of 33,589 Pascals (0.336 atm) for 10 minutes. The material is then packaged into 300 mL cartridges.

Samples were then tested with respect to their Extrusion Rate (in accordance with ASTM C 1183), flow/sag/slump (measured per ASTM C 639) and skin over time (SOT). SOT was measured in a fashion similar to ASTM C 679 but instead of using a strip of PE film, the skin over time was determined as the time to leave a bare fingertip clean when touched. The results are depicted in Table 2.

TABLE 2
Slump/extrusion rate/skin over time (SOT) Results
of Examples 1 to 3 and Comparative Examples 1 to 3

| | C.1 | C.2 | C.3 | D.1 | D.2 | C.4 |
|---|---|---|---|---|---|---|
| Slump/Flow (over 10 | >100 | >100 | 96 | 15 | 8 | 91 |
| min) (mm) | | | | | | |
| Initial Extrusion | 1333 | 1536 | 1449 | 1530 | 1331 | 824 |
| Rate (g/min) | | | | | | |
| Initial Skin over | ~12-15 | ~12-15 | ~27 | ~32 | ~25 | ~14 |
| time (SOT) (min) | | | | | | |

### Comparable Example 1 & 2

C.1 was produced using a low shear method. C.2 was made on a high shear dental mixer but produced poor slump. Both C.1 and C.2 compositions were very flowable and exhibited little thixotropic behavior regardless of preparation technique used.

### Comp Example 3 (C.3)

Despite having a similar composition to developmental Example 1, Comp Example 3 (C.3) shows poor thixotropic behavior when prepared using a low shear bench mixer.

### Developmental Examples 1 and 2

These were prepared using a high shear mixer. Whilst displaying significantly better thixotropic behavior as witnessed from the slump measurement for D.2 which was prepared using a high shear dental mixer. Developmental examples 1 and 2 showed that it was necessary to mix using a high shear mixing. 12 batches on the high shear batch mixer into two pails. Samples were sprayed onto a vertical wall and coatings of up to about 19 mm were applied and minimal flow/slump was visualized. However, whilst delivering the required thixotropic nature and not having flow/slump issues they unfortunately proved to have too high a viscosity and as such were not pumpable through a suitably long hose system.

A second series of examples were then prepared, in which samples of D.1 above were prepared along with five additional samples. The compositions prepared are depicted in Table 3 below.

TABLE 3
Compositions of a second set of Examples - prepared
using a laboratory twin screw extruder (high shear)

| | D.1 | D.3 | D.4 | IE.1 | IE.2 | IE.3 |
|---|---|---|---|---|---|---|
| Polymer 1 | 42.43 | 42.41 | 47.01 | 46.99 | 41.03 | 41.03 |
| Precipitated Calcium | 30 | 30 | 6.47 | 15.39 | 7.25 | 17.25 |
| Carbonate | | | | | | |
| Ground Calcium carbonate 1 | 24.1 | 24.1 | 43.1 | 34.2 | 48.3 | 38.3 |
| Methyltrimethoxysilane | 2.57 | 2.57 | 2.57 | 2.57 | 2.57 | 2.57 |
| N-(3-(Trimethoxysilyl) | 0.07 | 0.07 | | | | |
| propyl)-1,2- | | | | | | |
| ethanediamine | | | | | | |
| Titanate Catalyst | 0.9 | 0.85 | 0.85 | 0.85 | 0.85 | 0.85 |

D.3, D.4 and inventive examples 1-3 (IE.1 to IE.3) were all prepared using a twin-screw extruder. All extrusion experiments were performed on a modular 25 mm Co-Rotating, fully intermeshing twin screw extruder manufactured by Krupp Werner and Pfleiderer (Coperion). The extruder is powered by a 21.5 kW AC motor with a flux vector drive capable of generating screw speeds of up to 1200 rpm. The actual diameter of each screw is 25 mm and the channel depth is 4.15 mm. The free space cross sectional area is 3.2 cm². The overall length to diameter ratio of the machine is 48:1 L/D (12 barrels) having a total free processing volume of 0.384 liters. The screw elements that were utilized consisted of a right-handed conveying screw and a left-handed conveying screw and kneading blocks.

The resulting compositions were then tested for final viscosity of the composition using a Brookfield™ DV-II+Pro Programmable viscometer using spindle 7 at a shear rate of 10 rpm. The coating thickness achieved before slump/flow (mm) was determined using a wet film comb and is an average value. Results are shown for each sample in Table 4.

TABLE 4
Property results of the compositions

| | D.1 | D.3 | D.4 | IE.1 | IE.2 | IE.3 |
|---|---|---|---|---|---|---|
| Viscosity (Pa · s) | | 163 | 25.6 | 59.6 | 47.2 | 97.0 |
| Extrusion Rate (g/min) (ASTM C1183) | 1428 | 1766 | 2894 | 2404 | 2452 | 2022 |
| Extrusion Rate increase over ICD (%) | — | 24 | 103 | 68 | 72 | 42 |
| Coating Thickness before slump (mm) | >19 | >19 | 1.65 | 3.302 | 3.302 | 3.56 |

Developmental example D.3 was substantially the same composition as D.1 but was made on the twin screw extrude rather than via the high-speed mixer. When tested for extrusion rate it showed a small improvement in extrusion rate compared to original D.1.

In the case of D.3, D.4 and the inventive examples IE.1 to IE.3, samples were prepared with a view to modifying the composition until optimized compositions were prepared which gave a suitable pumpable composition (i.e. had a sufficiently low viscosity to enable the uncured composition to be transported through the hose arrangement, was sprayable using suitable spray guns such that a substrate could be coated with the one-part room temperature curable and sprayable ablative silicone composition herein in a single coating of a suitable coat thickness e.g. 2.5 mm to 5 mm, alternatively 2.5 mm to 4.45 mm thickness and this was achieved in the case of IE.1 to IE.3.

The coating thickness achieved before slump/flow (mm) was determined using a wet film comb gauge and was an average value and was between 2.5 mm and 4.45 mm in the case of the inventive examples.

The composition of IE. 2 was tested for cure in depth using the Corporate Test Method CTM 0663 which is available to the public upon request. It was found to have cured approximately 0.28 mm after 24 hours which was considered satisfactory.

In order to provide evidence of good physical properties for the cured ablative coating material depicted in IE. 2, physical property tests were undertaken and the results are depicted in Table 5 below.

TABLE 5
Physical property results of IE. 2

| Test | IE. 2 |
|---|---|
| Shore A Hardness | 53 |
| Tensile Strength (MPa) | 1.641 |
| Elongation at Break (%) | 236 |
| Modulus at 100% elongation (MPa) | 1.165 |

Shore A hardness was measured in accordance with ASTM D2240;

Tensile Strength, elongation at break and modulus at 100% extension were measured in accordance with ASTM D412.

Furthermore, the ablative properties of IE.2 were compared with those of comparative 4 (Comp. 4). As discussed previously to achieve this the coatings were exposed to an acetylene-oxygen torch. The torch was a Rose bud tip torch using an oxy acetylene mixture which resulted in a torch output temperature of approximately 3500° C. For all experiments depicted in Table 6 the torch was held at approximately 0.75 inches (1.9 cm) from the ablative coating surface during testing.

The substrates used were ceramic tile test pieces and the ablative coating thickness for each sample was typically between 2.9 and 3.5 mm thick.

### Penetration Rate

Respective ablative coatings of C.4 and IE.2 were applied on to a substrate surface and cured. The penetration rate indicated in Table 6 was an average of 10 samples. Each sample was exposed to the torch for a period of 10 seconds and the penetration rate was determined for each sample by taking thickness measurements of the substrate and coating using a set of calipers before the period of exposure to the lamp, exposing the coating to the torch for 10 seconds and remeasuring the thickness of each sample after exposure to the torch. The difference was then divided by the exposure time to obtain the penetration rate.

### Bulk Weight Loss

Respective ablative coatings of C.4 and IE.2 were applied on to a substrate surface and cured. Bulk weight loss was measured by determining the weight of the coating and substrate before exposure to the torch and remeasuring the weight after a 10 second exposure to the torch and determining the difference.

### Exposure Period

Respective ablative coatings of C.4 and IE.2 were applied on to a ceramic tile surface and cured. The resulting coating was exposed to the torch until the sample coating was compromised i.e. no further coating was present on the substrate at the point of exposure.

The results are depicted in Table 6.

TABLE 6
Ablative properties of coatings made from IE. 2 and C. 4

| | Penetration | Bulk weight | Exposure period survived |
|---|---|---|---|
| | Rate | Loss | on ceramic tile |
| Product | (mm/sec) | (g/sec) | substrate (seconds) |
| C. 4 | 0.3 | 1.35 | 12 |
| IE. 2 | 0.16 | 0.53 | 20 |

It will be appreciated that the Example herein IE.2 gave an improved response to the testing when compared with C.4.

1. A method for providing a substrate with an ablative coating, the method comprising the steps of:
(I) preparing a one-part room temperature curable and sprayable ablative silicone composition by mixing at high shear in a high shear mixer and/or using a twin-screw extruder, wherein the one-part room temperature curable and sprayable ablative silicone composition comprises:
(a) an organopolysiloxane of the structure
D—Z—(R¹)_{y}SiO_{(4-y)/2})_{z}—SiR¹₂—Z—D
wherein D is either;
(i) —Si—RₙX₃₋ₙ or
(ii) —Si(R¹)₂—O—Si(R¹)(O—Si(R¹)₂—Z¹—Si—RₙX₃₋ₙ)₂
wherein each R¹ is the same or different and is an alkyl group, alkenyl group or aryl group, each Z and Z¹ is a divalent organic group, the average value of y is about 2, z is the number average degree of polymerization and is an integer of at least 50, each X is a hydroxyl group or an alkoxy group, each R is individually selected from an alkyl group, an aminoalkyl group, a polyaminoalkyl group, an epoxyalkyl group, an alkenyl group or an aromatic group, and n is 0, 1 or 2;
(b) precipitated calcium carbonate having a BET surface area of at least 15 m²/g, optionally wherein component (b) is hydrophobically treated;
(c) one or more non-fibrous, non-reinforcing fillers;
wherein the cumulative wt. % of components (b) and (c) is from 40 to 60 wt. % of the composition and the weight ratio of component (b) to component (c) is from 1:2 to 1:7;
(d) a silane cross-linker having the structure
R⁷_{c}—Si—R⁶_{4-c}
wherein each R⁷ is an alkoxy group having from 1 to 10 carbons, a ketoximino group or an alkenyloxy group; each R⁶ is selected from a non-hydrolysable silicon-bonded organic group, and c is 2, 3 or 4; and
(e) a titanate or a zirconate condensation reaction catalyst;
which composition is substantially free from diluents or solvents; and
which one-part room temperature curable and sprayable ablative silicone composition resulting from step (I) has an extrusion rate of 1900 to 2600 g/min when measured in accordance with ASTM C1183;
(II) spraying the resulting mixture of step (I) onto a substrate surface to produce a thixotropic curable coating on the substrate which has a coating thickness before any visible indication of slump/flow of from 2.5 to 5 mm measured using a wet film comb gauge; and
(III) allowing the composition to cure at room temperature.

2. The method for providing a substrate with an ablative coating in accordance with claim 1, wherein component (c) is ground calcium carbonate.

3. The method for providing a substrate with an ablative coating in accordance with claim 1, wherein the mixing at high shear is done using a twin screw extruder.

4. The method for providing a substrate with an ablative coating in accordance with claim 1, wherein the one-part room temperature curable and sprayable ablative silicone composition resulting from step (I) has a viscosity of between 40 Pa·s and 125 Pa·s using a Brookfield™ DV-II+Pro Programmable viscometer using spindle 7 at a shear rate of 10 rpm measured at 25° C.

5. The method for providing a substrate with an ablative coating in accordance with claim 1, wherein during step (III) the one-part room temperature curable and sprayable ablative silicone composition cures such that the ablative coating cures at a rate such that there is a cure in depth in 24 hours of between 0.25 cm to 0.6 cm.

6. The method for providing a substrate with an ablative coating in accordance with claim 1, wherein the substrate is a steel structure, a cement trench, a rocket, a heat shield, a rocket engine, a missile, a missile nose cone, a missile deployment device, a spacecraft, an aerospace vehicle, a rocket part, are-entry space vehicle, a missile part, a launch pad, or an aircraft part.

7. The method for providing a substrate with an ablative coating in accordance with claim 1, wherein the one-part room temperature curable and sprayable ablative silicone composition resulting from step (I)
has a viscosity of between 40 Pa·s and 100 Pa·s using a Brookfield™ DV-II+Pro Programmable viscometer using spindle 7 at a shear rate of 10 rpm measured at 25° C. and/or
has an extrusion rate of from 1900 to 2500 g/min when measured in accordance with ASTM C1183 and/or
the thixotropic curable coating on the substrate is provided with a coating thickness before any visible indication of slump/flow of from 2.5 to 4.45 mm depth measured using a wet film comb gauge.

8. The method for providing a substrate with an ablative coating in accordance with claim 1, wherein the high shear mixer is operated at a rate of at least 500 revolutions per minute (rpm) or with a tip speed of greater than 3.25 ms⁻¹.

9. An article having an ablative coating obtainable or obtained by the method in accordance with claim 1.

10. An article having an ablative coating which is the cured product of a one-part room temperature curable and sprayable ablative silicone composition, the composition comprising:
(a) an organopolysiloxane of the structure
D—Z—(R¹)_{y}SiO_{(4-y)/2})_{z}—SiR¹₂—Z—D
wherein D is either;
(i) —Si—RₙX₃₋ₙ or
(ii) —Si(R¹)₂—O—Si(R¹)(O—Si(R¹)₂—Z¹—Si—RₙX₃₋ₙ)₂
wherein each R¹ is the same or different and is an alkyl group, alkenyl group or aryl group, each Z and Z¹ is a divalent organic group, the average value of y is about 2, z is the number average degree of polymerization and is an integer of at least 50, each X is a hydroxyl group or an alkoxy group, each R is individually selected from an alkyl group, an aminoalkyl group, a polyaminoalkyl group, an epoxyalkyl group, an alkenyl group or an aromatic group, and n is 0, 1 or 2;
(b) precipitated calcium carbonate having a BET surface area of at least 15 m²/g, optionally wherein component (b) is hydrophobically treated;
(c) one or more non-fibrous, non-reinforcing fillers;
wherein the cumulative wt. % of components (b) and (c) is from 40 to 60 wt. % of the composition and the weight ratio of component (b) to component (c) is from 1:2 to 1:7;
(d) a silane cross-linker having the structure
R⁷_{c}—Si—R⁶_{4-c}
wherein each R⁷ is an alkoxy group having from 1 to 10 carbons, a ketoximino group or an alkenyloxy group; each R⁶ is selected from a non-hydrolysable silicon-bonded organic group, and c is 2, 3 or 4; and
(e) a titanate or a zirconate condensation reaction catalyst;
which one-part room temperature curable and sprayable ablative silicone composition is substantially free from diluents or solvents and has an extrusion rate of 1900 to 2600 g/min when measured in accordance with ASTM C1183; and
where after being sprayed onto a substrate surface to produce a thixotropic curable coating thereon has a coating thickness before any visible indication of slump/flow of from 2.5 to 5 mm measured using a wet film comb gauge.

11. The article in accordance with claim 10, which is selected from a steel structure, a cement trench, a rocket, a heat shield, a rocket engine, a missile, a missile nose cone, a missile deployment device, a spacecraft, an aerospace vehicle, a rocket part, a re-entry space vehicle, a missile part, a launch pad, or an aircraft part.

12-15. (canceled)

16. A one-part room temperature curable and sprayable ablative silicone composition comprising:
(a) an organopolysiloxane of the structure
D—Z—(R¹)_{y}SiO_{(4-y)/2})_{z}—SiR¹₂—Z—D
wherein D is either;
(i) —Si—RₙX₃₋ₙ or
(ii) —Si(R¹)₂—O—Si(R¹)(O—Si(R¹)₂—Z¹—Si—RₙX₃₋ₙ)₂
wherein each R¹ is the same or different and is an alkyl group, alkenyl group or aryl group, each Z and Z¹ is a divalent organic group, the average value of y is about 2, z is the number average degree of polymerization and is an integer of at least 50, each X is a hydroxyl group or an alkoxy group, each R is individually selected from an alkyl group, an aminoalkyl group, a polyaminoalkyl group, an epoxyalkyl group, an alkenyl group or an aromatic group, and n is 0, 1 or 2;
(b) precipitated calcium carbonate having a BET surface area of at least 15 m²/g, optionally wherein component (b) us hydrophobically treated;
(c) one or more non-fibrous, non-reinforcing fillers;
wherein the cumulative wt. % of components (b) and (c) is from 40 to 60 wt. % of the composition and the weight ratio of component (b) to component (c) is from 1:2 to 1:7;
(d) a silane cross-linker having the structure
R⁷_{c}—Si—R⁶_{4-c}
wherein each R⁷ is an alkoxy group having from 1 to 10 carbons, a ketoximino group or an alkenyloxy group; each R⁶ is selected from is a non-hydrolysable silicon-bonded organic group, and c is 2, 3 or 4; and
(e) a titanate or a zirconate condensation reaction catalyst;
which one-part room temperature curable and sprayable ablative silicone composition is substantially free from diluents or solvents and has an extrusion rRate of 1900 to 2600 g/min when measured in accordance with ASTM C1183; and
where after being sprayed onto a substrate surface to produce a thixotropic curable coating thereon has a coating thickness before any visible indication of slump/flow of from 2.5 to 5 mm measured using a wet film comb gauge.

17. The one-part room temperature curable and sprayable ablative silicone composition in accordance with claim 16, wherein component (c) is ground calcium carbonate.
